(19) United States
(12) Patent Application Publication
(10) Pub. No.: US 2026/0001492 A1
(43) Pub. Date: Jan. 1, 2026

(54) ELECTRIFIED UNDER-SEAT STORAGE DRAWER

(71) Applicant: Scout Motors, Inc., Tysons, VA (US)

(72) Inventors: Sean DeGennaro, Van Buren Township, MI (US); Robert Shipley, Westland, MI (US); Heather Harrelson, Saline, MI (US)

(21) Appl. No.: 18/758,546

(22) Filed: Jun. 28, 2024

(51) Int. Cl. B60R 7/04; B60R 16/03

(52) U.S. Cl. CPC B60R 7/043; B60R 16/03

(57) ABSTRACT

An electrified under-seat storage drawer may include a platform movable between an extended position and a retracted position. An electrified under-seat storage drawer may include an accessory slot coupled to the platform and including a neutral power port, a hot power port, and a reader port selectively inhibiting electrical power from communicating with the hot power port. An electrified under-seat storage drawer may include an accessory module selectively couplable with and receiving electrical power from the accessory slot when the reader port detects the presence of the accessory module.

### BACKGROUND

This disclosure relates to vehicle storage. More particularly, this disclosure relates to seating area storage for vehicles.

### SUMMARY

In some aspects, the techniques described herein relate to an electrified under-seat storage drawer including: a platform movable between an extended position and a retracted position; an accessory slot coupled to the platform and including a neutral power port, a hot power port, and a reader port selectively inhibiting electrical power from communicating with the hot power port; and an accessory module selectively couplable with and receiving electrical power from the accessory slot when the reader port detects the presence of the accessory module.

In some aspects, the techniques described herein relate to an electrified under-seat storage drawer, wherein the accessory slot is a first accessory slot, the electrified under-seat storage drawer further including: a second accessory slot coupled to the platform; and a third accessory slot coupled to the platform.

In some aspects, the techniques described herein relate to an electrified under-seat storage drawer, further including: a structural guide rail coupled to the platform and constraining movement of the platform between the extended position and the retracted position.

In some aspects, the techniques described herein relate to an electrified under-seat storage drawer, further including: an electrified rail configured to be electrically coupled to a vehicle wiring harness, the electrified rail including a hot rail and a neutral rail in moveable electrical connection with the platform and providing electrical power to the accessory slot.

In some aspects, the techniques described herein relate to an electrified under-seat storage drawer, wherein the electrified rail is stationary, the electrified under-seat storage drawer further including: a hot pickup coupled to the platform and in movable electrical communication with the stationary hot rail; and a neutral pickup coupled to the platform and in movable electrical communication with the stationary neutral rail.

In some aspects, the techniques described herein relate to an electrified under-seat storage drawer, further including: a backing plate coupled to the platform and extending vertically therefrom to inhibit user access rearward of the platform.

In some aspects, the techniques described herein relate to an electrified under-seat storage drawer, wherein the platform moves toward a vehicle front when moving from the retracted position to the extended position.

In some aspects, the techniques described herein relate to an electrified under-seat storage drawer, wherein the platform is sized to be received in a drawer cavity formed below a center seat of a vehicle.

In some aspects, the techniques described herein relate to an electrified under-seat storage drawer, further including a back wall inhibiting access to the platform from a rear of a vehicle.

In some aspects, the techniques described herein relate to an electrified under-seat storage drawer, wherein the accessory module includes: a module housing; a hot connection coupled to the module housing and selectively electrically coupled to the hot power port of the accessory slot; a neutral connection coupled to the module housing and selectively electrically coupled to the neutral power port of the accessory slot; and a reader connection coupled to the module housing and structured to interact with the reader port of the accessory slot, wherein the accessory slot inhibits electrical communication to the hot power port when the reader connection is disconnected from the reader port of the accessory slot.

In some aspects, the techniques described herein relate to an electrified under-seat storage drawer, wherein the accessory module includes a module latch sized to selectively engage a slot latch of the accessory slot to inhibit removal of the accessory module from the accessory slot.

In some aspects, the techniques described herein relate to an electrified under-seat storage drawer, wherein the accessory module is a charging module.

In some aspects, the techniques described herein relate to an electrified under-seat storage drawer, wherein the accessory module is a cup holder module including a heating element or a cooling element.

In some aspects, the techniques described herein relate to an electrified under-seat storage drawer, wherein the accessory module is a lidded cubby including a light.

In some aspects, the techniques described herein relate to an electrified under-seat storage drawer, wherein the accessory module is an air conditioning module including a heat exchanger and a fan.

In some aspects, the techniques described herein relate to an electrified storage drawer for a vehicle, the electrified storage drawer including: a structural guide rail; an electrified rail extended parallel to the structural guide rail; a platform supported by the structural guide rail and the electrified rail for movement between an extended position and a retracted position; and an accessory slot coupled to the platform and including a neutral power port, a hot power port, and a reader port selectively inhibiting electrical communication between the electrified rail and the hot power port.

In some aspects, the techniques described herein relate to an electrified storage drawer, wherein the reader port includes a microswitch inhibiting electrical communication between the electrified rail and the hot power port in an open position and providing electrical communication between the electrified rail and the hot power port in a closed position.

In some aspects, the techniques described herein relate to an electrified storage drawer, further including an accessory module selectively engaged with the accessory slot and including: a module housing; a hot connection coupled to the module housing and selectively electrically coupled to the hot power port of the accessory slot; a neutral connection coupled to the module housing and selectively electrically coupled to the neutral power port of the accessory slot; and a reader connection coupled to the module housing and structured to interact with the reader port of the accessory slot.

In some aspects, the techniques described herein relate to a vehicle seat defining a drawer cavity, the vehicle seat including: a structural guide rail positioned within the drawer cavity; an electrified rail positioned within the drawer cavity and extended parallel to the structural guide rail; a platform supported by the structural guide rail and the electrified rail for movement between an extended position and a retracted position; and a plurality of accessory slots coupled to the platform and selectively receiving electrical power from the electrified rail; an accessory module removably coupled to one or more of the plurality of accessory slots and receiving electrical power therefrom.

In some aspects, the techniques described herein relate to a vehicle seat, wherein electrical power communication between the one or more of the plurality of accessory slots and the electrified rail is inhibited when the accessory module is removed from the one or more of the plurality of accessory slots.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The device is explained in even greater detail in the following drawings. The drawings are merely exemplary and certain features may be used singularly or in combination with other features. The drawings are not necessarily drawn to scale.

FIG. 1 is a top view of an electrified under-seat storage drawer, according to some implementations.

FIG. 2 is a top view of a first accessory, according to some implementations.

FIG. 3 is a top view of a second accessory, according to some implementations.

FIG. 4 is a top view of a third accessory, according to some implementations.

FIG. 5 is a side view of the electrified under-seat storage drawer of FIG. 1, according to some implementations.

FIG. 6 is a front view of the electrified under-seat storage drawer of FIG. 1, according to some implementations.

FIG. 7 is a top view of the electrified under-seat storage drawer of FIG. 1, according to some implementations.

FIG. 8 is atop view of an electrified guide rail of the electrified under-seat storage drawer of FIG. 1, according to some implementations.

FIG. 9 is a section view of the electrified guide rail of FIG. 8, according to some implementations.

FIG. 10 is a schematic view of the electrified under-seat storage drawer of FIG. 1 including a portable air conditioning accessory, according to some implementations.

FIG. 11 is a perspective view of the portable air conditioning accessory of FIG. 10, according to some implementations.

### DETAILED DESCRIPTION

Following below are more detailed descriptions of concepts related to, and implementations of, methods, apparatuses, and systems for an electrified under-seat storage drawer for a vehicle. The figures illustrate exemplary implementations in detail and the present disclosure is not limited to the details or methodology set forth in the description or illustrated in the figures. The terminology used herein is for the purpose of description only and should not be regarded as limiting.

As used herein the term “battery electric vehicle” means a vehicle (e.g., a passenger vehicle, a delivery vehicle, etc.) for use by humans or a self-driving vehicle that is powered entirely by a battery system including battery cells. In other words, no fossil fuels are utilized, no internal combustion engine is present in the vehicle, and no alternative forms of propulsion is provided (e.g., hydrogen fuel cells, etc.). In some implementations, features of this disclosure can be used with hybrid vehicles, such as plug-in hybrid vehicles, hybrid vehicles (e.g., full hybrid vehicles), mild hybrid electric vehicles, and range extended hybrid vehicles. Features of this disclosure are also usable with vehicles that are not battery electric vehicles. For example, an electrified under-seat storage drawer as described below can be used with an internal combustion engine powered vehicle.

Referring to the figures generally, the various implementations disclosed herein relate to systems, apparatuses, and methods for an electrified under-seat storage drawer. The electrified under-seat storage drawer provides multiple accessory slots (e.g., three) that are each structured to receive an accessory module. The electrified under-seat storage drawer slides car forward (i.e., opens as a drawer toward a front of the vehicle) from underneath a seat, and is accessible to all occupants in a row of seats of the vehicle. The accessory modules may include a wireless charger module, an illuminated cooled and/or heated dual cupholder module, an illuminated lidded bin module, and the like. A fixed or portable air conditioning module can also be included. The accessory slots of the electrified under-seat storage drawer is moveably supported on an electrified rail and a slide rail. The electrified rail eliminates the need for a moveable wiring harness and increases the long-term reliability of the electrified under-seat storage drawer. Each of the accessory slots is powered when an accessory module is installed thereon, and depowered when no module is installed to inhibit a user from experiencing an electrical shock and/or inadvertently grounding the electrical system.

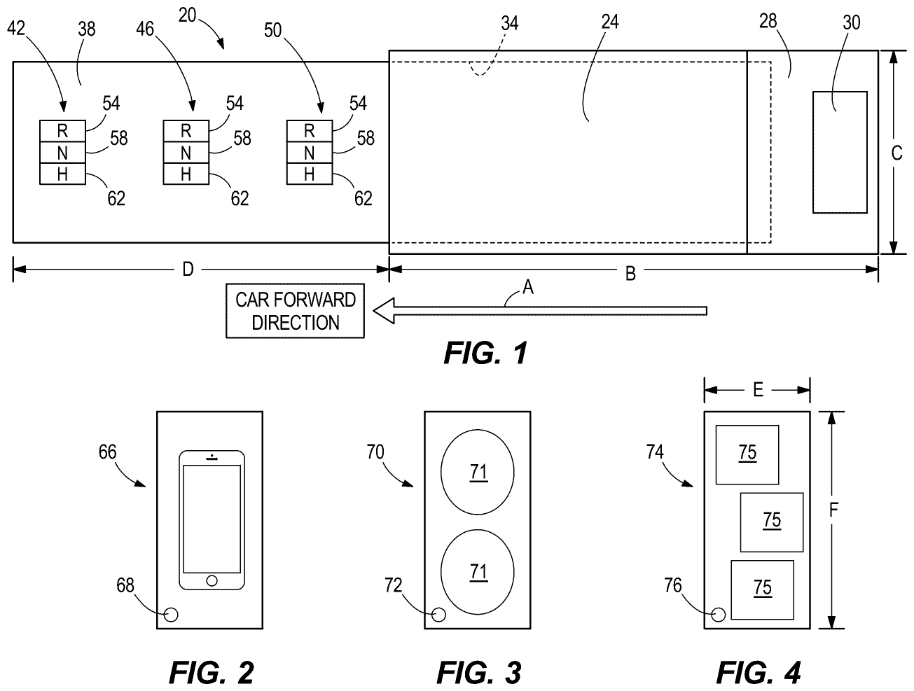

As shown in FIG. 1, an electrified under-seat storage drawer 20 can be installed under a center console or a seat 24 to provide additional storage and utility in a commonly underutilized area of a vehicle. In some implementations, the seat 24 includes a backrest 28 and a headrest 30. In some implementations, the seat 24 is a center seat of a front bench seat of a vehicle. The seat 24 defines a drawer cavity 34 positioned under the seat 24.

The electrified under-seat storage drawer 20 includes a platform 38 sized to be moveably received within the drawer cavity 34 and movable between an extended position (shown in FIG. 1) and a retracted position with the platform 38 encompassed within the seat 24. In some instances, the electrified under-seat storage drawer 20 includes a first accessory slot 42, a second accessory slot 46, and a third accessory slot 50 each structured to receive an accessory module. In some implementations, the electrified under-seat storage drawer 20 includes more than three or less than three accessory slots. Each of the accessory slots is mounted to the platform 38 and moveable therewith. Each of the accessory slots includes receptor ports in the form of a reader port 54 that identifies the presence or absence of an accessory module, a neutral power port 58 selectively providing a neutral electrical path, and a hot power port 62 selectively providing a hot electrical path. In some implementations, the reader port 54, the neutral power port 58, and/or the hot power port 62 are female ports or are otherwise integrated into a female receptacle/interface. In this manner, the electrified components of the first accessory slot 42, the second accessory slot 46, and/or the third accessory slot 50 are at least partially concealed to inhibit accidental contact or unintentional grounding. However, it should be appreciated that the present disclosure is not limited in this regard.

In some implementations, the electrified under-seat storage drawer 20 is arranged so that moving toward the extended position includes moving parallel to a vehicle forward direction A. In some implementations, the electrified under-seat storage drawer 20 is structured to open in a direction other than forward (e.g., rearward, or to a left or right side of the vehicle).

In some implementations, the seat 24 defines a seat length B of 400 mm. In some implementations, the seat length B is 350 mm to 450 mm. In some implementations, the seat 24 defines a seat width C of 220 mm. In some implementations, the seat width C is 200 mm to 240 mm. In some implementations, the electrified under-seat storage drawer 20 defines an open drawer length D that the electrified under-seat storage drawer 20 extends outside the seat 24. In some implementations, the open drawer length is 375 mm. In some implementations, the open drawer length D is 325 mm to 425 mm.

As shown in FIG. 2, a first accessory module in the form of a charging module 66 includes a direct current (DC) device charger in the form of a wireless (e.g., inductive) charger capable of charging a mobile phone or other devices. In some implementations, the charging module 66 includes a wired charger (e.g., in addition to or in lieu of a wireless charger) which is configured to charge devices through a physical connection (e.g., a USB-C style connector). The charging module 66 is engageable with any of the first accessory slot 42, the second accessory slot 46, or the third accessory slot 50 to receive power and hold an electronic device in place while the vehicle is in use and/or driving. In some implementations, the charging module 66 is engageable with a combination of multiple slots, dependent upon power supply requirements of the charging module 66. The charging module 66 includes an indicator light 68 that illuminates when the charging module 66 is installed in the electrified under-seat storage drawer 20 and receiving power from one of the first accessory slot 42, the second accessory slot 46, or the third accessory slot 50. In some implementations, the indicator light 68 includes multiple color outputs that indicate a status of the charging module. For example, the indicator light 68 can display red when connected to power and green when charging. In some implementations, the indicator light 68 may blink to indicate a status of the charging module 66 (e.g., a high temperature status).

As shown in FIG. 3, a second accessory module in the form of a cup holder module 70 includes two cup holder cavities 71, a heating element, a cooling element, and a light. The cup holder module 70 is engageable with any of the first accessory slot 42, the second accessory slot 46, or the third accessory slot 50 to receive power and hold one or more objects (e.g., a cup, a travel mug, etc.) in place while the vehicle is in use and/or driving. The cup holder module 70 can selectively provide heat or chill to the two cup holder cavities 71 via the heating element and/or the cooling element. In some implementations, the cup holder module 70 includes a switch to activate or deactivate the heating element. In some implementations, the heating element includes a thermostat to maintain the two cup holder cavities 71 at a desired temperature (e.g., to keep coffee hot). For example, a temperature measured by the thermostat could be used to selectively activate, deactivate, or otherwise control the heating element and/or the cooling element. The light provides illumination to aid in user convenience and ability to see items within the electrified under-seat storage drawer 20. The cup holder module 70 includes an indicator light 72 that illuminates when the cup holder module 70 is installed in the electrified under-seat storage drawer 20 and receiving power from one of the first accessory slot 42, the second accessory slot 46, or the third accessory slot 50. In some implementations, the indicator light 72 includes multiple color outputs that indicate a status of the cup holder module 70. For example, the indicator light 72 can display red when heating and blue when cooling. In some implementations, the indicator light 72 may blink to indicate a status of the cup holder module 70 (e.g., a high temperature status). In some implementations, the cup holder module 70 is engageable with a combination of multiple slots, dependent upon power supply requirements of the cup holder module 70.

As shown in FIG. 4, a third accessory module in the form of a lidded cubby 74 includes a housing defining a cavity sized to store small objects, a lid selectively covering the cavity, and three lights 75. In some implementations, the housing and the lid are formed from a transparent or translucent material (e.g. a smoke-colored plastic). In some implementations, the lid is connected to the housing with a hinge. In some implementations, more than three lights 75 or less than three lights 75 are included. The three lights 75 are powered to provide illumination when the lidded cubby 74 is installed in the electrified under-seat storage drawer 20 and receiving power from one of the first accessory slot 42, the second accessory slot 46, or the third accessory slot 50. Additionally, an indicator light 76 illuminates when the lidded cubby 74 is installed in the electrified under-seat storage drawer 20 and receiving power from one of the first accessory slot 42, the second accessory slot 46, or the third accessory slot 50. In some implementations, the three lights 75 allow the lidded cubby 74 to be used as a light source (e.g., a light cube or a flashlight) that may be used when installed in the electrified under-seat storage drawer 20 or when remote from the electrified under-seat storage drawer 20 (e.g., a detachable light source).

The electrified under-seat storage drawer 20 can include other accessory modules (e.g., a speaker, a laptop charger, a portable air conditioning unit, a fan, an air purifier, etc.) as desired. The first accessory slot 42, the second accessory slot 46, and the third accessory slot 50 can be populated with any accessory module, or a combination of multiple slots dependent upon power supply requirements, as desired by the end user. As shown in FIG. 4, in some implementations, the accessory modules define a module length E parallel with the direction of travel A of 125 mm. In some implementations, the module length E is 100 mm to 150 mm. In some implementations, the accessory modules define a module width F of 210 mm. In some implementations, the module width is 185 mm to 235 mm.

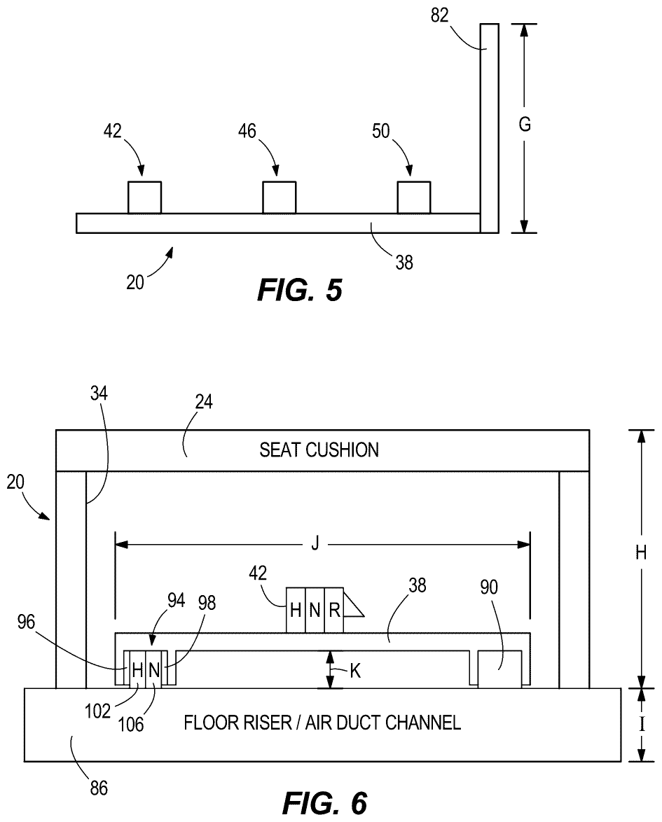

As shown in FIG. 5, the electrified under-seat storage drawer 20 includes a backing plate 82 that is connected to the platform 38 and moves therewith. The backing plate 82 inhibits user access into the drawer cavity 34 when the electrified under-seat storage drawer 20 is in the extended position. In some implementations, the backing plate 82 defines a backing plate height G of 175 mm. In some implementations, the backing plate height G is 125 mm to 225 mm.

As shown in FIG. 6, the seat 24 is supported on a vehicle floor 86 and defines a cavity height H of 205 mm. In some implementations, the cavity height H is 180 mm to 230 mm.

The platform 38 is supported on the vehicle floor 86 by a structural guide rail 90 (e.g., a drawer slide, a linear bearing, etc.) that constrains movement of the platform 38 between the extended position and the retracted position, and an electrified rail 94 that provides power to the first accessory slot 42, the second accessory slot 46, and the third accessory slot 50.

The electrified rail 94 includes a hot pickup 96 and a neutral pickup 98 connected to the platform 38 and moveable therewith. In some implementations, the hot pickup 96 and the neutral pickup 98 are brushes or another slidable electrical connection. The electrified rail 94 also includes a hot rail 102 that extends within the drawer cavity 34 and is shaped to be engaged by the hot pickup 96 and a neutral rail 106 that extends within the drawer cavity 34 and is shaped to be engaged by the neutral pickup 98. The electrified rail 94 provides electrical communication between an electrical harness of the vehicle and the electrified under-seat storage drawer 20 for use by accessory modules (e.g., the charging module 66).

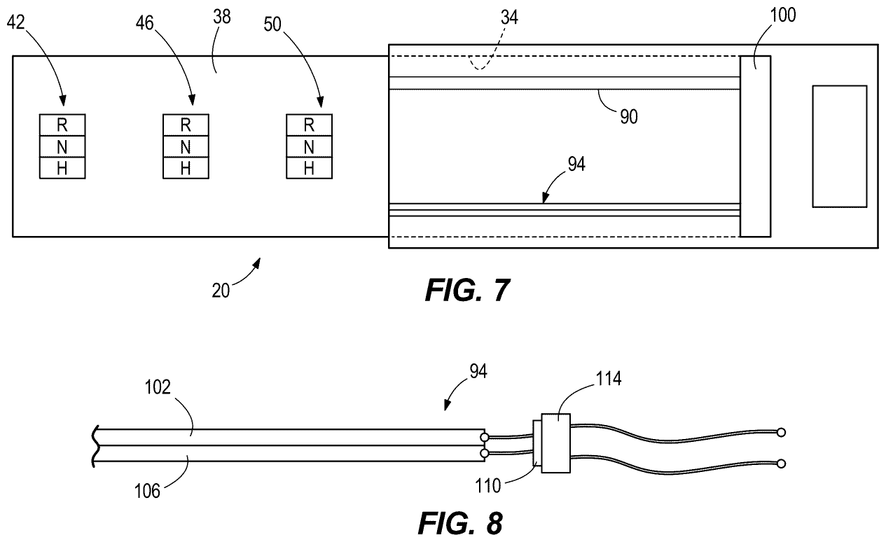

As shown in FIG. 7, the structural guide rail 90 and the electrified rail 94 extend parallel to the direction of travel A within the seat length B of the drawer cavity 34. The seat 24 also includes a back wall 100 that inhibits access of backrow passengers into the drawer cavity 34. As shown in FIG. 8, the electrified rail 94 includes a connector 110 that is shaped to engage a vehicle wiring harness 114. The connector 110 is generally used to supply 12-volt DC power to the electrified rail 94, though in some implementations the supplied power may be at different voltages and may be direct-current or alternating-current.

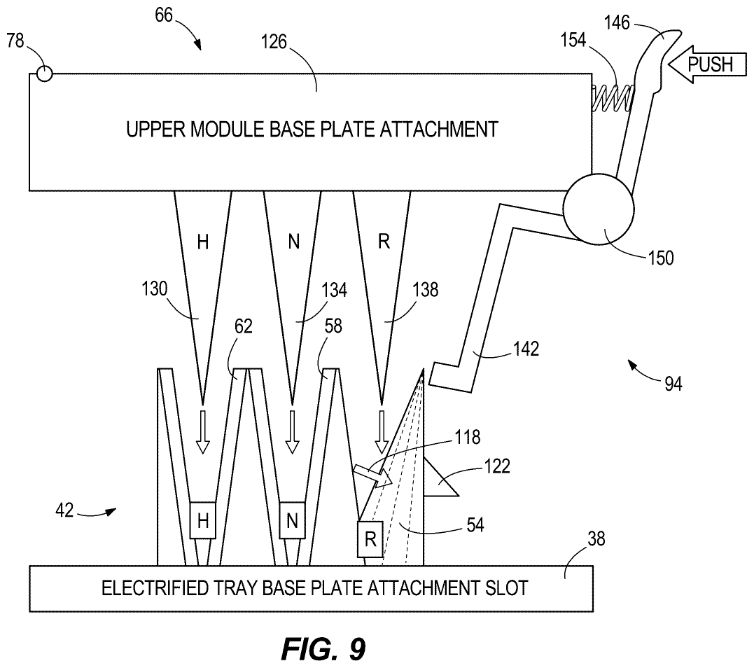

As shown in FIG. 9, the first accessory slot 42 is in communication with the electrified rail 94 and includes the reader port 54, the neutral power port 58, the hot power port 62. In some implementations, the neutral power port 58 and the hot power port 62 are generally wedge shaped. The reader port 54 is structured to sense or otherwise recognize the presence or absence of an accessory module (e.g., the charging module 66) and control the flow of electricity between the electrified rail 94 and the first accessory slot 42 based on the presence or absence. In some implementations, the reader port 54 includes sensor in the form of a microswitch 118. In some implementations, the microswitch 118 is a spring biased, normally off switch that inhibits electrical communication between the electrified rail 94 and the first accessory slot 42 in an off position and provides electrical communication between the electrified rail 94 and the first accessory slot 42 in an on position. In some implementations, the sensor includes an optical sensor, or another electrical component that selectively inhibits the flow of electricity to the first accessory slot 42. For example, an optical sensor can detect the presence or absence of a module and a controller can selectively provide or inhibit a flow of electrical power to the module based on information received from the sensor. The first accessory slot 42 also includes a slot latch 122 extending from the reader port 54 and structured to physically engage the charging module 66 to inhibit removal of the charging module 66 from the first accessory slot 42. In some implementations, the slot latch 122 is positioned on the platform 38 or another portion of the first accessory slot 42.

The charging module 66 (and the other accessory modules) includes a module housing 126, a hot connection 130 structured to electrically couple with the hot power port 62, a neutral connection 134 structured to electrically couple with the neutral power port 58, and a reader connection 138 structured to interact with the microswitch 118 of the reader port 54 to verify the presence of the charging module 66 installed in the first accessory slot 42. The charging module 66 also includes a module latch 142 shaped to engage the slot latch 122 and movable between an engaged position and a disengaged position by a handle 146. The module latch 142 is rotatable between the engaged position and the disengaged position about a pivot 150 and is biased toward the engaged position by a spring 154. The features discussed herein with reference to the charging module 66 are also present on the cup holder module 70 and the lidded cubby 74 and other accessory modules. The features discussed herein with reference to the first accessory slot 42 are also present on the second accessory slot 46 and the third accessory slot 50. In some implementations, power is cut to the electrified rail 94 when one or more of the accessory slots are empty (e.g., the reader port 54 of one or more slots does not recognize an accessory module and the reader port 54 inhibits a flow of electrical power to the electrified rail 94 either directly or via a controller). In some implementations, power is cut to the hot power port 62 when the associated reader port 54 does not recognize an accessory module.

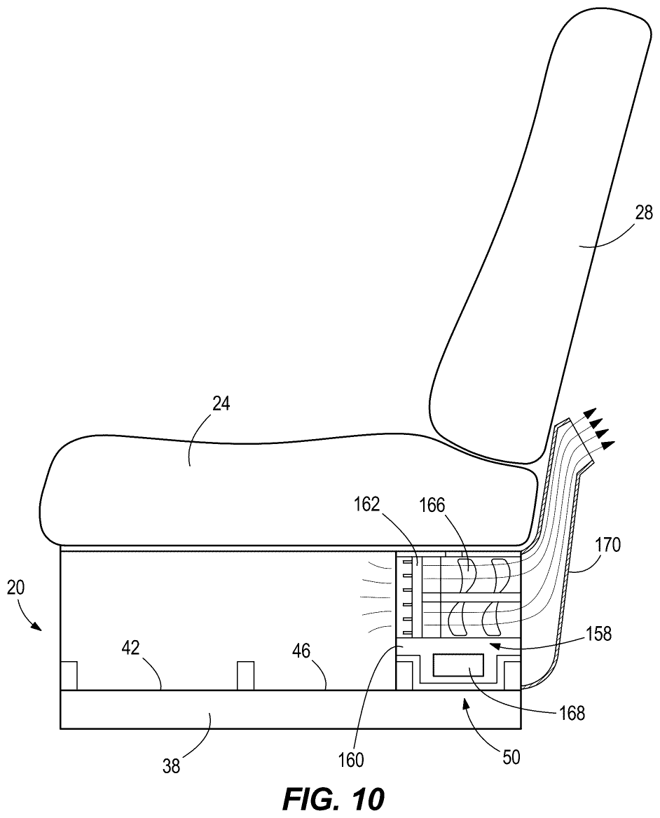

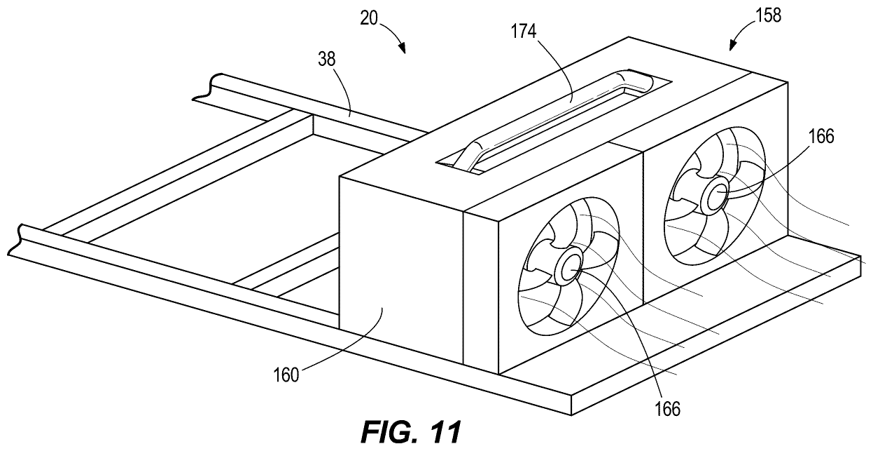

As shown in FIGS. 10 and 11, an air conditioning module 158 can be positioned to provide auxiliary air flow and/or cooling to a rear row of seats within the vehicle. The air conditioning module 158 is structured to be installed in the third accessory slot 50 and includes a AC housing 160, a heat exchanger 162, and fans 166. In some implementations, the air conditioning module 158 receives electrical power from the third accessory slot 50. In some implementations, the air conditioning module 158 includes a battery 168 that powers the fans 166 and/or the heat exchanger 162. In some implementations, the battery 168 is charged by the third accessory slot 50.

In some implementations, the seat 24 includes a modular detachable duct 170 that connects to the back wall 100 to provide communication with the air conditioning module 158 and the rear seat or rear area of the vehicle. In some implementations, the modular detachable duct 170 replaces the back wall 100 (e.g., the back wall 100 is removed or eliminated). The air conditioning module 158 includes a handle 174 and can be removed/detached from the electrified under-seat storage drawer 20 and can be used as a battery-powered air conditioning unit for camping and/or tailgating. In some implementations, the air conditioning module 158 communicates with the vehicle via a wired tether or via wireless data communication frequency to integrate with a vehicle HVAC temperature setting. The air conditioning module 158 can be used as a portable air conditioned and/or fan (e.g., for tailgating on a hot day, while working under the vehicle for repairs or in other areas with limited airflow, as a portable air conditioned while camping in a tent, etc.). The air conditioning module 158 can also advantageously reduce vehicle charging time for a battery electric vehicle. For example, while charging an occupied vehicle, a user can operate the air conditioning module 158 to remain comfortable while the primary HVAC system of the vehicle is inactive, thereby saving energy and charging the vehicle batteries faster.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. An electrified under-seat storage drawer comprising:
a platform movable between an extended position and a retracted position;
an accessory slot coupled to the platform and including
a neutral power port,
a hot power port, and
a reader port selectively inhibiting electrical power from communicating with the hot power port; and
an accessory module selectively couplable with and receiving electrical power from the accessory slot when the reader port detects the presence of the accessory module.

2. The electrified under-seat storage drawer of claim 1, wherein the accessory slot is a first accessory slot,
the electrified under-seat storage drawer further comprising:
a second accessory slot coupled to the platform; and
a third accessory slot coupled to the platform.

3. The electrified under-seat storage drawer of claim 1, further comprising:
a structural guide rail coupled to the platform and constraining movement of the platform between the extended position and the retracted position.

4. The electrified under-seat storage drawer of claim 1, further comprising:
an electrified rail configured to be electrically coupled to a vehicle wiring harness, the electrified rail including a hot rail and a neutral rail in moveable electrical connection with the platform and providing electrical power to the accessory slot.

5. The electrified under-seat storage drawer of claim 4, wherein the electrified rail is stationary,
the electrified under-seat storage drawer further comprising:
a hot pickup coupled to the platform and in movable electrical communication with the stationary hot rail; and
a neutral pickup coupled to the platform and in movable electrical communication with the stationary neutral rail.

6. The electrified under-seat storage drawer of claim 1, further comprising:
a backing plate coupled to the platform and extending vertically therefrom to inhibit user access rearward of the platform.

7. The electrified under-seat storage drawer of claim 1, wherein the platform moves toward a vehicle front when moving from the retracted position to the extended position.

8. The electrified under-seat storage drawer of claim 1, wherein the platform is sized to be received in a drawer cavity formed below a center seat of a vehicle.

9. The electrified under-seat storage drawer of claim 1, further comprising a back wall inhibiting access to the platform from a rear of a vehicle.

10. The electrified under-seat storage drawer of claim 1, wherein the accessory module includes:
a module housing;
a hot connection coupled to the module housing and selectively electrically coupled to the hot power port of the accessory slot;
a neutral connection coupled to the module housing and selectively electrically coupled to the neutral power port of the accessory slot; and
a reader connection coupled to the module housing and structured to interact with the reader port of the accessory slot,
wherein the accessory slot inhibits electrical communication to the hot power port when the reader connection is disconnected from the reader port of the accessory slot.

11. The electrified under-seat storage drawer of claim 10, wherein the accessory module includes a module latch sized to selectively engage a slot latch of the accessory slot to inhibit removal of the accessory module from the accessory slot.

12. The electrified under-seat storage drawer of claim 1, wherein the accessory module is a charging module.

13. The electrified under-seat storage drawer of claim 1, wherein the accessory module is a cup holder module including a heating element or a cooling element.

14. The electrified under-seat storage drawer of claim 1, wherein the accessory module is a lidded cubby including a light.

15. The electrified under-seat storage drawer of claim 1, wherein the accessory module is an air conditioning module including a heat exchanger and a fan.

16. An electrified storage drawer for a vehicle, the electrified storage drawer comprising:
a structural guide rail;
an electrified rail extended parallel to the structural guide rail;
a platform supported by the structural guide rail and the electrified rail for movement between an extended position and a retracted position; and
an accessory slot coupled to the platform and including a neutral power port, a hot power port, and a reader port selectively inhibiting electrical communication between the electrified rail and the hot power port.

17. The electrified storage drawer of claim 16, wherein the reader port includes a microswitch inhibiting electrical communication between the electrified rail and the hot power port in an open position and providing electrical communication between the electrified rail and the hot power port in a closed position.

18. The electrified storage drawer of claim 16, further comprising an accessory module selectively engaged with the accessory slot and including:
a module housing;
a hot connection coupled to the module housing and selectively electrically coupled to the hot power port of the accessory slot;
a neutral connection coupled to the module housing and selectively electrically coupled to the neutral power port of the accessory slot; and
a reader connection coupled to the module housing and structured to interact with the reader port of the accessory slot.

19. A vehicle seat defining a drawer cavity, the vehicle seat comprising:
a structural guide rail positioned within the drawer cavity;
an electrified rail positioned within the drawer cavity and extended parallel to the structural guide rail;
a platform supported by the structural guide rail and the electrified rail for movement between an extended position and a retracted position; and
a plurality of accessory slots coupled to the platform and selectively receiving electrical power from the electrified rail;
an accessory module removably coupled to one or more of the plurality of accessory slots and receiving electrical power therefrom.

20. The vehicle seat of claim 19, wherein electrical power communication between the one or more of the plurality of accessory slots and the electrified rail is inhibited when the accessory module is removed from the one or more of the plurality of accessory slots.
